(19) United States
(12) Patent Application Publication
(10) Pub. No.: US 2022/0026746 A1
(43) Pub. Date: Jan. 27, 2022

(54) EYEWEAR VENTILATION APPARATUS

(71) Applicant: Edward D. Lewis, Brownsburg, IN (US)

(72) Inventor: Edward D. Lewis, Brownsburg, IN (US)

(73) Assignee: The Order Fulfillment Group Inc., Zionsville, IN (US)

(21) Appl. No.: 17/386,283

(22) Filed: Jul. 27, 2021

Related U.S. Application Data
(63) Continuation of application No. 63/057,056, filed on Jul. 27, 2020.

(51) Int. Cl. G02C 11/08; F16L 3/02

(52) U.S. Cl. CPC G02C 11/08; A62B 18/006; F16L 3/02

(57) ABSTRACT

In one embodiment, an eyewear ventilation apparatus is provided, including a fan, a manifold, a plurality of tubes, and a directional device. The fan includes an inlet and an outlet. The manifold is in fluid communication with the outlet of the fan. Each of the plurality of tubes includes an inlet and an outlet. The inlet of each of the plurality of tubes is in fluid communication with the manifold. The directional device is configured to secure at least one of the plurality of tubes to a temple of an eyewear device. The directional device is also configured to direct fluid from the outlet of the at least one of the plurality of tubes onto a region.

### CROSS-REFERENCE TO RELATED APPLICATIONS

This application claims priority of Provisional Application Ser. No. 63/057,056 filed Jul. 27, 2020, entitled “Eyewear Ventilation Apparatus.”

### TECHNICAL FIELD

This disclosure relates to accessories related to eyewear and, in particular, to systems for ventilating eyewear.

### BACKGROUND

The statements in this section merely provide background information related to the present disclosure and may not constitute prior art.

Medical facemasks are increasingly being used in a wide variety of public interactions. However, humid air from the interior of the facemask often leaks out from the sides of the facemasks. For mask wearers who also use eyewear devices, the humid air can cause eyewear devices to fog up, decreasing visibility. For medical procedures such as surgeries or dental examinations, loss of visual clarity can put patients at serious risk. Therefore, a ventilation device is needed which will allow mask wearers to continue to use eyewear devices effectively.

### SUMMARY

Further areas of applicability will become apparent from the description provided herein. It should be understood that the description and specific examples are intended for purposes of illustration only and are not intended to limit the scope of the present disclosure.

In one embodiment, an eyewear ventilation apparatus is provided, including a fan, a manifold, a plurality of tubes, and a directional device. The fan includes an inlet and an outlet. The manifold is in fluid communication with the outlet of the fan. Each of the plurality of tubes includes an inlet and an outlet. The inlet of each of the plurality of tubes is in fluid communication with the manifold. The directional device is configured to secure at least one of the plurality of tubes to a temple of an eyewear device. The directional device is also configured to direct fluid from the outlet of the at least one of the plurality of tubes onto a region.

In another embodiment, an eyewear system is provided including an eyewear device and a ventilation apparatus. The eyewear system includes a front portion, a first temple, and a second temple. The front portion extends from a first end to a second end. The first temple is coupled to the first end of the front portion. The second temple is coupled to the second end of the front portion. The ventilation apparatus includes a fan, a manifold, a first tube, a second tube, and a directional device. The fan includes an inlet and an outlet. The manifold is in fluid communication with the outlet of the fan. The first tube includes a first inlet in fluid communication with the manifold, and a first outlet. The second tube includes a second inlet in fluid communication with the manifold, and a second outlet. The directional device is coupled to the first tube and is configured to secure the first tube to the first temple of the eyewear device. The directional device is also configured to direct fluid from the first outlet of the first tube to onto the front portion of the eyewear device.

In yet another embodiment, a clip is provided including a body, a first prong, a second prong, a third prong, and a receptacle. The clip is configured to couple a tube to a temple of an eyewear device. The body includes a first side and a second side. The body extends from a first end to a second end. The first prong extends downward from the body on the first side. The second prong extends downward from the body on the second side. The third prong extends downward from the body on one of the first side or the second side. The first prong, the second prong, and the third prong are each configured to engage the temple of the eyewear device. The receptacle extends outward from the body and is configured to receive the tube.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates a top plan view of an example of an eyewear system including a ventilation apparatus and an eyewear device;

FIG. 2 illustrates a partial cross-sectional front view of a second example of the eyewear system including the ventilation apparatus, the eyewear device, and a mask;

FIG. 3 illustrates a rear plan view of a third example of the eyewear system including the ventilation apparatus, the eyewear device, and a wearable heatsink;

FIG. 4 illustrates a side plan view of a fourth example of the eyewear system including the ventilation apparatus, the eyewear device, and the mask;

FIG. 5 illustrates a perspective view of an example of a clip;

FIG. 6 illustrates a perspective view a fifth example of the eyewear system including the ventilation apparatus and the eyewear device;

FIG. 7 illustrates a perspective view of a second example of the clip;

FIG. 8 illustrates a perspective view of a third example of the clip;

FIG. 9 illustrates a side plan view of an example of a fan and a fan housing;

FIG. 10 illustrates a perspective view of a second example of the fan housing;

FIG. 11 illustrates an electrical diagram of an example of the ventilation apparatus;

FIG. 12 illustrates an electrical diagram of a second example of the ventilation apparatus;

FIG. 13 illustrates an electrical diagram of a third example of the ventilation apparatus; and

FIG. 14 illustrates a perspective view of a sixth example of the eyewear system including the ventilation apparatus and the eyewear device.

The drawings described herein are for illustration purposes only and are not intended to limit the scope of the present disclosure in any way.

### DETAILED DESCRIPTION

The following description is merely exemplary in nature and is not intended to limit the present disclosure, application, or uses.

In one example, an eyewear ventilation apparatus is provided, including a fan, a manifold, a plurality of tubes, and a directional device. The fan includes an inlet and an outlet. The manifold is in fluid communication with the outlet of the fan. Each of the plurality of tubes includes an inlet and an outlet. The inlet of each of the plurality of tubes is in fluid communication with the manifold. The directional device is configured to secure at least one of the plurality of tubes to a temple of an eyewear device. The directional device is also configured to direct fluid from the outlet of the at least one of the plurality of tubes onto a region.

One technical advantage of the systems and methods described below may be that the ventilation apparatus may prevent eyewear devices from fogging up in humid environments, or where humid fluid leaks from a mask onto the eyewear device. Another technical advantage of the systems and methods described below may be that the ventilation apparatus may be configured to fit a variety of different eyewear devices.

Yet another technical advantage of the systems and method described herein may be that the ventilation apparatus may be used to maintain positive pressure within a mask, creating a more hygienic environment for the user. Yet another technical advantage of the systems and method described herein may be that the ventilation apparatus may filter and clean fluid delivered to the eyewear device and the mask, also creating a more hygienic environment for the user.

Yet another technical advantage of the systems and method described herein may be that several components of the ventilation apparatus may be easily interchangeable, replaceable, and customizable, including batteries, tubes, filters, and clips. This flexibility allows the ventilation apparatus to be used for a longer period of time and function for a wider variety of users and eyewear devices. Yet another technical advantage of the systems and method described herein may be that the ventilation apparatus may include an internal battery to facilitate changing of external batteries while ensuring continuous operability of the ventilation apparatus.

Yet another technical advantage of the systems and method described herein may be that the ventilation apparatus may regulate the temperature and pressure of fluid delivered to the mask and to the eyewear device, allowing for functionality in a wide variety of environmental conditions. Yet another technical advantage of the systems and method described herein may be that the ventilation apparatus may be adjustable to direct fluid flow onto specific area of the eyewear device, ensuring continued visibility by the user on critical areas of the user's sight lines, and ensuring that the ventilation apparatus is functionally responsive to changing conditions of use.

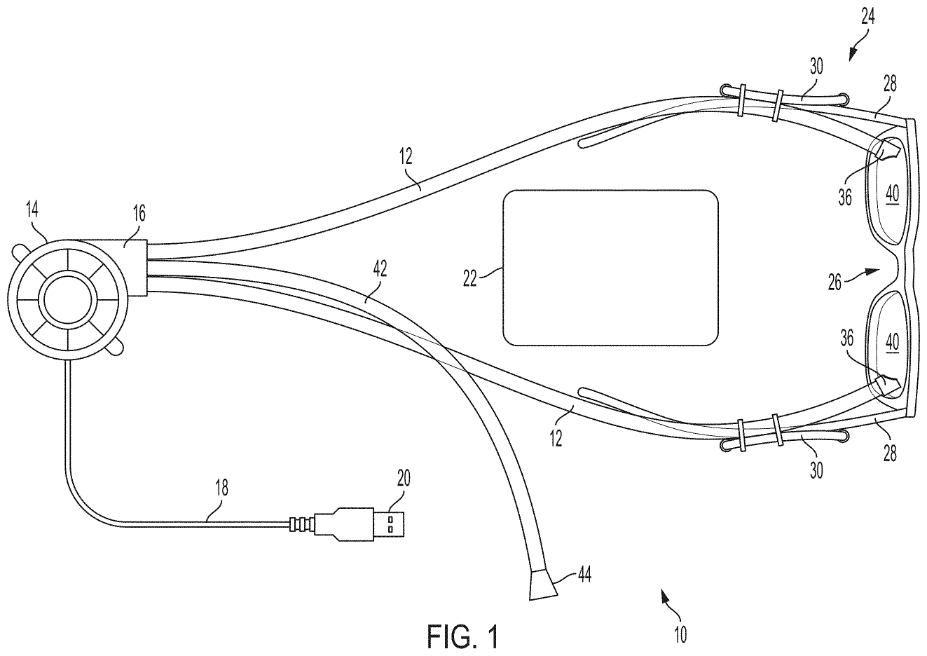

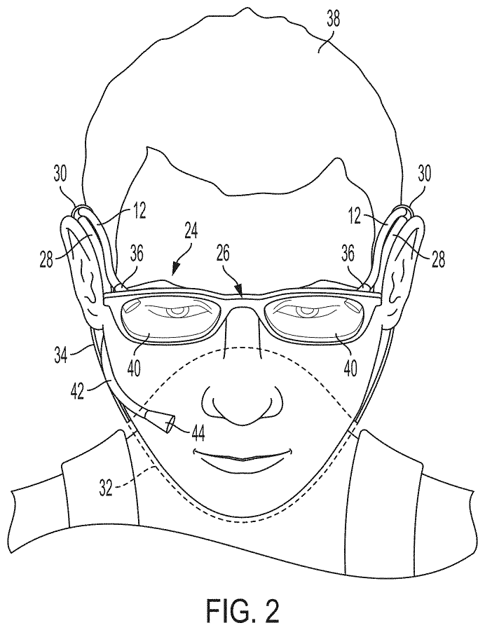

FIG. 1 illustrates a cross-sectional side view of a first example of an eyewear system including an eyewear device 24 and a ventilation apparatus 10. The eyewear device 24 may be any device which is configured to extend over a user's (38 in FIG. 2) eyes and allow vision through a portion of the eyewear device 24. Examples of the eyewear device 24 may include eye glasses, goggles, safety glasses, face shields, and full-face masks. The eyewear device 24 may include a front portion 26 and one or more lens (40 in FIG. 2).

The eyewear device 24 may include a front portion 26 extending from a first end to a second end, and one or more temples 28. The front portion 26 may be any portion of the eyewear device 24 which is adapted to extend across a user's 38 face. The lens 40 may be any portion of the front portion 26 which is at least partially transparent to allow the user 38 to see through the front portion 26. Examples of the lens 40 may include a pair of lenses, a single window extending from a first end of the front portion to a second end of the front portion, or a shield extending across the entire face of a user 38. The temple 28 may be any portion of the eyewear device 24 which is adapted to extend from the front portion 26 of the eyewear device 24 over an ear of a user 38. Examples of the temple 28 may include an elastic band extending around the head of a user 38, or rod extending from the front portion 26 and directly over and around the ear of a user 38. As illustrated in FIG. 1, the eyewear device 24 may have two temples 28, a first temple 28 coupled to the first end of the front portion 26, and a second temple 28 coupled to the second end of the front portion 26.

The ventilation apparatus 10 may be any device adapted to direct fluid onto a region such as a surface of a lens 40, some other area of the front portion 26, onto a surface of a face shield, or into an interior region of a mask (32 in FIG. 2). Examples of the ventilation apparatus 10 may include a portable fan, a fluid conduit providing forced air, or a water dispenser. The ventilation apparatus 10 may include a fan 14, a manifold, 16, one or more tubes 12, (42 in FIG. 2), a clip 30, an electrical source 22, and an electrical connector 20.

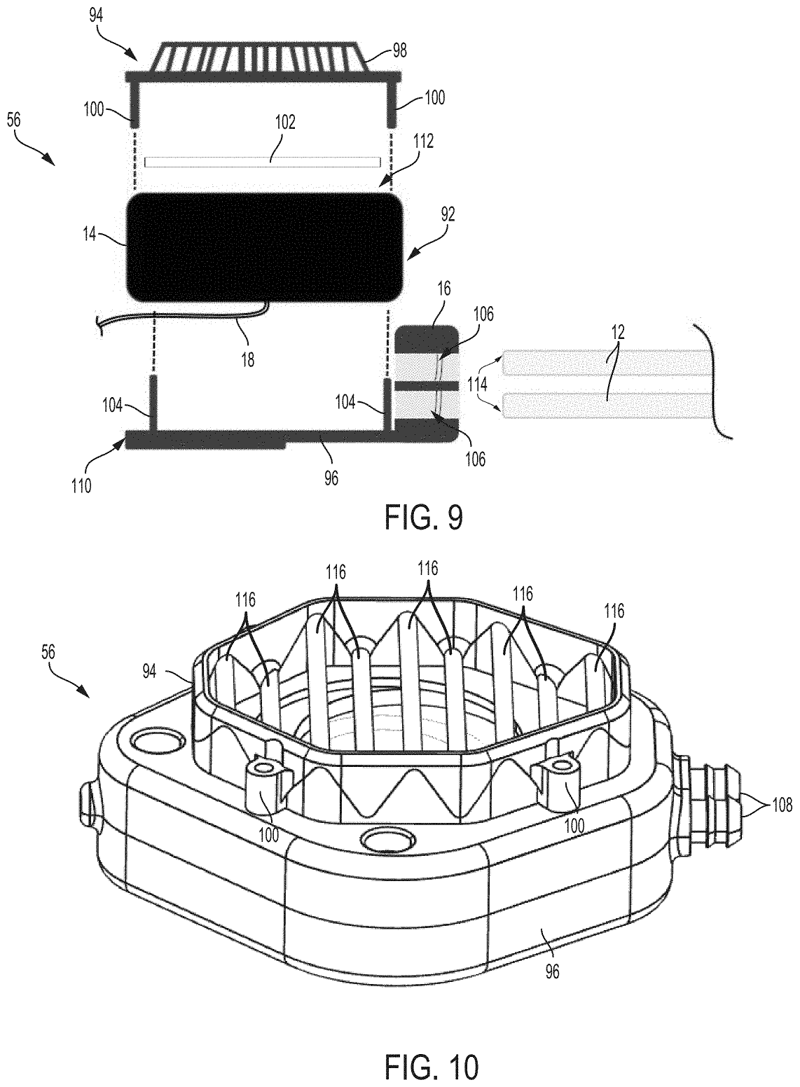

The fan 14 may be any device which is adapted to intake fluid and direct the fluid in a direction. Examples of the fan 14 may include an axial flow fan, a centrifugal fan, a cross-flow fan, bellows, a convective fluid flow device, or an electrostatic fluid accelerator. The fan 14 may include an inlet (112 in FIG. 9) and an outlet (92 in FIG. 9). The fan 14 may receive fluid through the inlet 112, accelerate the fluid, and then direct the fluid through an outlet 92. The fan 14 may be driven by a motor, which may operate at a voltage of between 3 volts and 10 volts, but preferably between a voltage of 5 volts and 9 volts.

The manifold 16 may be any structure which is in fluid communication with the outlet 92 of the fan 14 and which is adapted to receive the tubes 12, 42. Examples of the manifold 16 may include a chamber, a compartment, or a port. In some embodiments, the manifold 16 may be the outlet 92 of the fan 14. The tubes 12 may be any object which is in fluid communication with the manifold 16 and which is adapted to direct fluid from the fan 14 to a region. Examples of the tubes 12, 42 may include circular conduits, flattened ducts, or a sealed channel. Between 1 and 4 tubes may be coupled to the manifold 16. The tubes 12, 42 may be made of plastic, silicone, or latex. The tubes 12, 42 may be transparent or may be opaque. The tubes 12, 42 may be sufficiently flexible to bend around the head of the user 38 and must be sufficiently rigid to consistently direct air to the respective region. The tubes 12, 42 may extend from an inlet (114 in FIG. 9) in fluid communication with the manifold 16 to an outlet proximate to the respective region where fluid is to be delivered.

The clip 30 may be any part which is adapted to secure at least one of the tubes 12, 42 to a temple 28 of the eyewear device 24, and which is adapted to direct fluid from the outlet of the respective tube 12, 42 to the region. Examples of the clip 30 may include complex interlocking structure, a series of interconnected bands, a directional device, or an integrated component of the eyewear device 24. As shown in FIG. 1, the clip 30 may include a first component adapted to be coupled to the temple 28 of the eyewear device 24 and a second component adapted to be coupled to one of the tubes 12, 42.

The electrical source 22 may be any component which is adapted as an energy source for the motor of the fan 14. Examples of the electrical source 22 may include an electrical outlet, a Lithium Ion battery, a Nickel Cadmium battery, an alkaline battery, or a Nickel Metal Hydride battery. In the event the electrical source 22 is a battery, the electrical source 22 may have a capacity between 150-32000 milliamp-hours and may sustain operation of the fan 14 for between 2 and 55 hours. For example, the battery electrical source 22 having a capacity of 2200 milliamp-hours may operate the fan 14 for 4 hours. Alternatively, a smaller electrical source 22 having a capacity of 150 milliamp-hours could be used which could be hung from the back of the ear or neck of the user, or even integrated into the temple 28 of the eyewear device 24. Such an embodiment may operate the fan 14 at a low speed for up to 2 hours.

The electrical connector 20 may be any component which is used to couple the fan 14 to the electrical source 22. Examples of the electrical source 22 may be an electrical wire having a type A plug, a cable having a USB power connector system, or a cable having a proprietary electrical connector system.

FIG. 2 illustrates a partial cross-sectional front view of the eyewear system including the ventilation apparatus 10, the eyewear device 24, and the mask 32. The mask 32 may be any device which is adapted to cover a portion of the face of the user 38. Examples of the mask 32 may include a medical respirator such as the N95 respirator, a surgical mask, a face shield, a bandana, or some other cloth extending across the face of a user 38. The mask 32 may be held on the face of the user 38 by a mask string 34 extending from an end of the mask 32 around a portion of the head of the user 38. The mask string 34 may be unitary, extending from one end of the mask 32, around the user's 38 head, and to the other, opposing end of the mask 32. Alternatively, the mask string 34 may extend from the top portion of the mask 32, around the ear of a user 38, and to a bottom portion of the mask 32. The mask 32 may contain between one and four mask strings 34. The mask string 34 may be made of any material capable of securing the mask 32 to the face of the user 38, including an elastic material such as rubber, twisted rope, or a strand of cloth.

As illustrated in FIG. 2, there may be multiple tubes 12, 42 associated with the ventilation apparatus 10. For example, the ventilation apparatus 10 may include two eyewear tubes 12, each adapted to provide fluid to the front portion 26 of the eyewear device 24 as well as one mask tube 42 adapted to provide fluid to an interior region of a mask 32. The outlet of the eyewear tube 12 may be coupled to an eyewear nozzle 36. The eyewear nozzle 36 may be any component of the eyewear tube 12 which shapes and directs the flow of fluid from the outlet of the eyewear tube 12 onto the front portion 26 of the eyewear device 24. The eyewear nozzle 36 may include a preformed curve, allowing fluid to blow across or into the lens 40 of the front portion 26. The eyewear nozzle 36 may also be hand-adjustable to allow a user to better direct fluid flow over the front portion 26. The outlet of the eyewear nozzle 36 may have a cross-sectional area which is less than a cross-sectional area of the eyewear tube 12, increasing the fluid flow rate of the fluid passing through the eyewear tube 12 and focusing the direction of the fluid to a more specific region. Alternatively, the outlet of the cross-sectional area of the eyewear nozzle 36 may be greater than the cross-sectional area of the eyewear tube 12, allowing fluid passing through the eyewear nozzle 36 to be more diffusely distributed across the front portion 26 while still confining the direction of fluid flow toward critical areas of the front portion 26. The outlet of the eyewear nozzle 36 may be circular or may have other shapes, such as a flattened rectangular shape or a curved-crescent shape. The outlet of the eyewear nozzle 36 may be any shape which more effectively directly onto the front portion 26 to prevent the accumulation of condensed fluid onto the lens 40 of the eyewear device 24.

The eyewear nozzle 36 may be made any of material sufficiently rigid to maintain its shape and direct fluid to the front portion 26. For example, the eyewear nozzle 36 may be made of silicone, polyurethane, nylon, or another polymer. The eyewear nozzle 36 may have a hardness which is greater than a hardness of the eyewear tube 12, to maximize the flexibility of the eyewear tube 12 while maintaining the effectiveness of the eyewear nozzle 36 at directing fluid flow. For example, the eyewear tube 12 may be made of silicone, while the eyewear nozzle 36 may be made of nylon. The eyewear tube 12 may be coupled to the eyewear nozzle 36 through a variety of methods including an interference fit, a barb fit, or a trouser clip. Alternatively, the eyewear nozzle 36 may be coupled to the eyewear tube 12 by a joint, such as a ball joint, a joint with a concertina-type hinge, or a circumferentially rotational joint.

The mask tube 42 may include a mask nozzle 44 coupled to the mask tube 42 at the outlet of the mask tube 42. The mask nozzle 44 may be any component of the mask tube 42 which shapes and directs the flow of fluid from the outlet of the mask tube 42 into an interior region of the mask 32. The interior region is defined as the space between the mask 32 and the covered portion of the user's 38 face while the mask 32 is secured to the user 38. The mask nozzle 44 may be hand-adjustable to allow a user to better direct fluid flow into the interior region of the mask 32. The outlet of the cross-sectional area of the mask nozzle 44 may be greater than the cross-sectional area of the mask tube 42, allowing fluid passing through the mask nozzle 44 to be more diffusely distributed into the interior region. The outlet of the mask nozzle 44 may be circular or may have other shapes, such as a flattened rectangular shape or a curved-crescent shape. A flattened mask nozzle 44 may be advantageous by being easier to slide the mask nozzle 44 into the interior region under one of the sides of the mask 32.

The mask nozzle 44 may be made any material sufficiently flexible to easily be positioned into the interior region of the mask 32. For example, the mask nozzle 44 may be made of silicone, polyurethane, or another polymer. The mask nozzle 44 may have a hardness which is less than a hardness of the mask tube 42, to minimize the difficulty of inserting the mask nozzle 44 into the interior region of the mask 32. The mask tube 42 may be coupled to the mask nozzle 44 through a variety of methods including an interference fit, a barb fit, or a trouser clip. Alternatively, the mask nozzle 44 may be coupled to the mask tube 42 by a joint, such as a ball joint, a joint with a concertina-type hinge, or a circumferentially rotational joint.

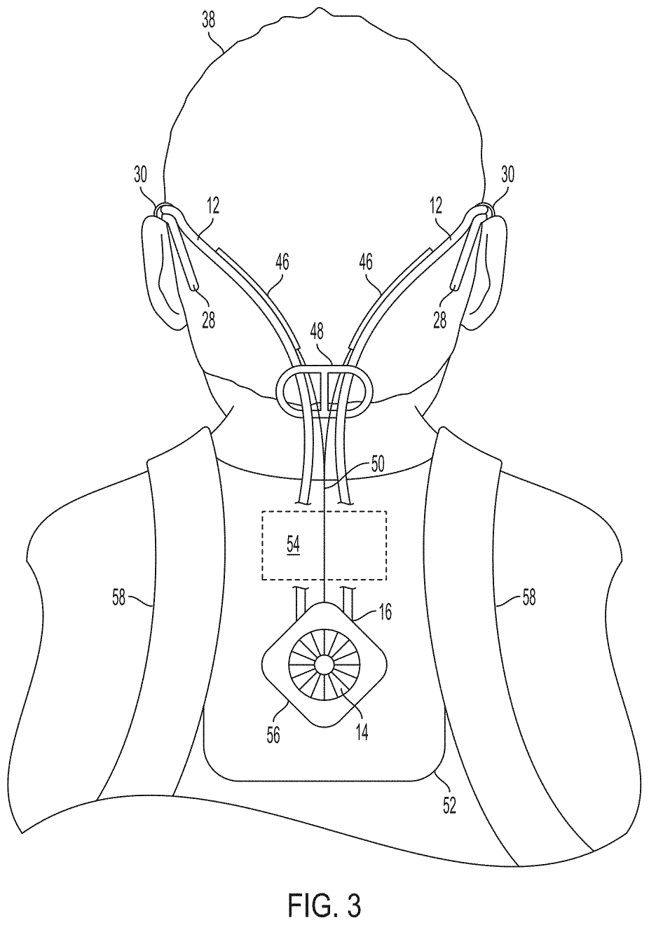

FIG. 3 illustrates a rear plan view of the eyewear system including the ventilation apparatus 10, the eyewear device 24, and a wearable heatsink 52. As illustrated in FIG. 3, the fan 14 and a fan housing 56 may extend along the back of the user 38 suspended by the tubes 12, 42. The fan housing 56 may be any device which encloses a portion of the fan 14. Examples of the fan housing 56 may include a casing or a frame. In some embodiments, the manifold 16 may be a part of the fan housing 56.

In some embodiments, fluid passing through the tubes 12, 42 may be conditioned through a temperature control system to adapt the ventilation apparatus 10 to different environmental conditions. For example, in certain ambient atmosphere conditions, blowing fluid at ambient temperature at the front portion 26 may be insufficient to prevent formation of condensation on the lens 40. Similarly, hot and humid air produced from breathing may make the interior region of the mask 32 uncomfortable to a user 38. Therefore, fluid from the fan 14 may need to be cooled before being delivered to the front portion 26 or to the interior region of the mask 32. In some embodiments, a temperature sensor may be included to detect the ambient temperature and provide information to the temperature control system to determine whether the fluid should be conditioned. In some embodiments, the temperature control system may heat the fluid passing through the tubes 12, 42. In other embodiments, the temperature control system may condition fluid passing through the eyewear tubes 12 differently than fluid passing through the mask tube 42.

In one embodiment, the ventilation apparatus 10 may include a heat exchanger 54 positioned between the fan 14 and the outlet of the tubes 12, 42. The heat exchanger 54 may be any region of the ventilation apparatus 10 adapted to condition fluid passing through the heat exchanger 54. In some embodiments, the heat exchanger 54 is adapted to cool fluid below an ambient temperature. Examples of the heat exchanger 54 may include a shell and tube heat exchanger, a cross-flow heat exchanger, or a cross/counter flow heat exchanger. In the embodiment illustrated in FIG. 3, the tubes 12, 42 are arranged to extend through the heat exchanger 54 and exchange fluid heat with a heatsink 52. The heatsink 52 may be any store of material having low thermal energy and which allows efficient thermal exchange from the fluid within the tube 12, 42 and to the heatsink 52. Examples of the material stored within the heatsink 52 may include water, air, or a refrigerant. As illustrated in FIG. 3, in some embodiments, the heatsink 52 may be integrated into a backpack or some other carrying device, having shoulder straps 58 which extend over a user's 38 shoulders. The fan 14 and fan housing 56 may be coupled to the heatsink 52 to reduce tension on the tubes 12, 42 and hold the fan 14 in a fixed position relative to the user 38. In some embodiments the heatsink 52 may contain material having high thermal energy which may be used to heat fluid passing through the tubes 12, 42 within the heat exchanger 54.

The ventilation apparatus 10 may also include a fastener 48 coupled to the eyewear tubes 12. The fastener 48 may be any device which is adapted to receive more than one of the eyewear tubes 12 and which can be moved along the length of the eyewear tubes 12. Examples of the fastener 48 may include a ring, a small cylinder, or a hollow disk. The fastener 48 may frictionally engage the eyewear tubes 12 to fix the position of the eyewear tubes 12 relative to the user's 38 head. In this way, the position of the eyewear tubes 12 may be tightened or loosened about the head of the user 38 to ensure that the ventilation apparatus 10 and eyewear device 24 remain on the user 38.

The ventilation apparatus 10 may also include a set of sanitary LED strips 46. The sanitary LED strips 46 may be any device which is adapted to cleanse fluid passing through the tubes 12, 42. The sanitary LED strips 46 may be coupled to the tubes 12, 42 between the fan 14 and the outlet of the tubes 12, 42 and may project ultraviolet germicidal radiation into the tubes 12, 42 to sterilize fluid passing through the tubes and kill microorganisms contained within the fluid. Because of health risks associated with ultraviolet radiations, the portion of the tubes 12, 42, overlapping with the sanitary LED strips 46 may be shielded such that ultraviolet radiation cannot reach the body of the user 38.

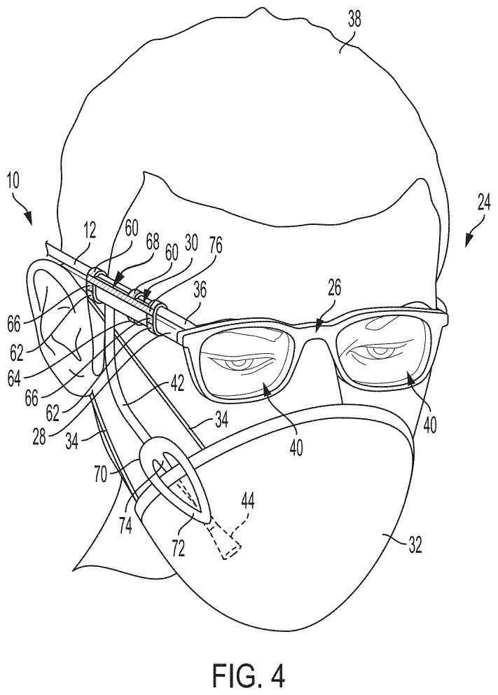

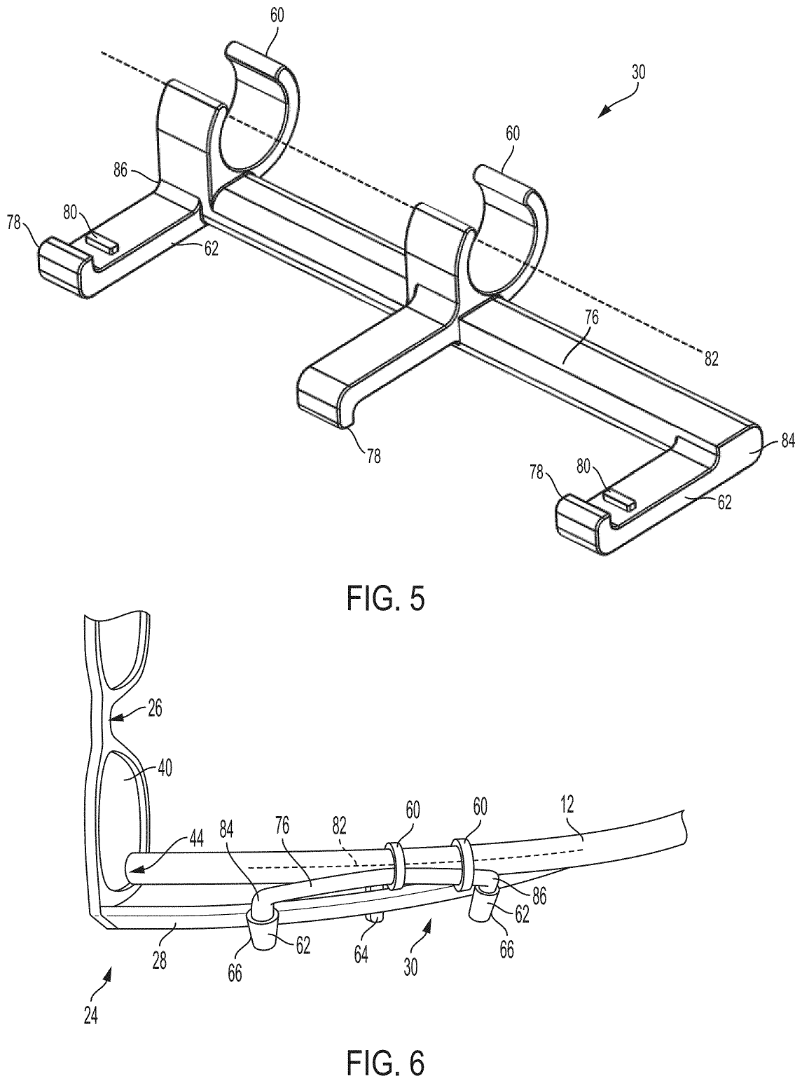

FIG. 4 illustrates a side plan view an example of the eyewear system including the ventilation apparatus 10, the eyewear device 24, and the mask 32. As illustrated in FIG. 4, the clip 30 may be coupled to the temple 28 of the eyewear device 24, through a series of prongs 62, 64 extending downward from a body 76 of the clip 30. The body 76 of the clip 30 may be any structure which is adapted to positioned alongside the temple 28 of the eyewear device 24. Examples of the body 76 may include an elongated element, a bar, or a rod. The body 76 has a front end (84 in FIG. 5) which is adapted to be closer to the eyewear device 24, and a back end (86 in FIG. 5) which is adapted to be further from the eyewear device 24 and close to the ear of the user 38. The prongs 62, 64 may be any component of the clip 30 which is adapted to engage temple 28 of the eyewear device 24 and to secure the clip 30 to the eyewear device 24. Examples of the prongs 62, 64 may include protrusions, fingers, or projections.

Although the prongs 62, 64 may be arranged on the body 76 of the clip 30 in a variety of ways, FIG. 4 illustrates one particular embodiment wherein one inner prong 64 extends downward from a first inner side of the body 76 of the clip 30, and two outer prongs 62 extend downward from a second outer side of the body 76. The prongs 62, 64 are adapted to receive the temple 28 of the eyewear device 24 between the inner prong 64 and the outer prong 62. Additionally, the outer prongs 62 may be positioned near the front end 84 and the back end 86 of the body 76 of the clip 30, while the inner prong 64 may be positioned between the outer prongs 62.

The clip 30 may be made of any material capable of engaging the clip 30 with the temple 28 of the eyewear device 24, such as aluminum, some other light-weight and flexible metal, or a plastic material such as polyurethane. The inner prong 64 and the outer prongs 62 may also include a cushion 66 made of a softer, more flexible material such as silicone or rubber. The cushion 66 may encircle one of the prongs 62, 64 to provide interfacing surfaces between the prong 62, 64 and the material of the temple 28. The cushion 66 may frictionally prevent the clip 30 from sliding along the length of the temple 28 once it has been attached. Furthermore, the cushion 66 may be used to better direct the orientation of the body 76 of the clip 30 with respect to the orientation of the temple 28.

The clip 30 may also include a receptacle 60 extending outward from the body 76 of the clip 30. The receptacle 60 may be any component of the clip 30 which is adapted to receive one of the tubes 12, 42. Examples of the receptacle 60 may include a partially circular crevice, a band encircling the tube 12, 42, or a zip-tie encircling both the body 76 of the clip 30 and the tube 12, 42. The tube 12, 42, may be frictionally fit into the receptacle 60 or may be rigidly coupled within the receptacle 60. As illustrated in FIG. 4, the clip 30 may include multiple receptacles 60, each receptacle 60 adapted to receive a different tube 12, 42 or adapted to receive a single tube 12, 42 in a sequential fashion. In embodiments where the receptacle 60 is adapted to receive an eyewear tube 12, such as in FIG. 4, the receptacle 60 may extend outwardly from the inner side of the body 76, which is the side of the body 76 closest to the head of the user 38. In other embodiments, the receptacle 60 may extend outwardly from the outer side of the body 76.

As illustrated in FIG. 4, the ventilation apparatus 10 may also include a mask fastener 70. The mask fastener 70 may be any component which is adapted to secure the mask tube 42 to the mask 32. Examples of the mask fastener 70 may include an alligator clip, a snap clip, or a barrette clip. The mask fastener 70 may have an inner portion 74 which is coupled to the mask tube 42 and which is adapted to be fit under the mask 32. The mask fastener 70 may also include an outer portion 72 which is adapted to extend over the mask 32. The inner portion 74 may be biased toward engagement with the outer portion 72 such that displacing one of the inner portion 74 or the outer portion 72 may create a restorative force which may be used to hold the mask fastener 70 to the mask 32. In some embodiments, such as where the mask fastener 70 is a snap clip, the outer portion 72 may be moveable between two stable configurations: a first position in which the outer portion 72 is biased toward the inner portion 74, and a second position in which the outer portion 72 is biased away from the inner portion 74. In such embodiments, the mask tube 42 and inner portion 74 of the mask fastener 70 may be positioned within the interior region of the mask 32 while the outer portion 72 is in the second position. Once the mask tube 42 has been positioned, the outer portion 72 may be moved to the first position to secure the mask tube 42 to the mask 32. In some embodiments, the mask fastener 70 may alternatively be clipped to a portion of a full face shield.

In some embodiments, the mask tube 42 may extend from the manifold independent from any of the other tubes 12, 42. Alternatively, as illustrated in FIG. 4, the mask tube 42 may extend downward from an opening 68 in the eyewear tube 12 and may be in fluid connection with the eyewear tube 12. The opening 68 in the eyewear tube 12 may be arranged between the inlet (114 in FIG. 9) and the outlet of the eyewear tube 12.

FIG. 5 illustrates a perspective view of an example of the clip 30. In some embodiments, the receptacles 60 may be aligned in sequence to define an axis 82 through the eyewear tube 12 may be directed toward the front portion 26 of the eyewear device 24. As illustrated in FIG. 5, the receptacles 60 may be set at different positions on the body 76 of the clip 30, orienting the axis 82 of the receptacles upward or downward relative to the orientation of the body 76 of the clip 30. This orientation offset may allow the eyewear tube 12 to be better directed toward the front portion 26 of the eyewear device 24 when the temple 28 is vertically offset from the front portion 26 or has an upward or downward curve.

Each of the inner prong 64 and outer prongs 62 may include a grip 78 at the bottom of the prong 62, 64. The grip 78 may be any component which allows the prong 62, 64 to extend under the bottom of the temple 28. Examples of the grip 78 may include a hook or a shelf. The grips 78 may extend inwardly toward a centerline of the body 76 of the clip 30 to better couple the clip 30 to the temple 28 of the eyewear device 24. The prongs 62, 64, may also have differing lengths from one another to accommodate temples 28 which have a varying height profile extending along the length of the temple 28.

The prongs 62, 64 may also include surface features 80. The surface features 80 may component adapted to engage the sides of the temple 28. Examples of the surface features 80 may include a protrusion, a groove, or a series of ridges. The surface features 80 may be arranged on an interior surface of the prongs 62, 64. The surface features 80 may extend inwardly toward the centerline of the body 76, but not as far inwardly as the grips 78. The surface features 80 may be adapted to engage with the surface of the temple 28 to frictionally secure the clip 30 to the temple 28. The surface features 80 may also engage with corresponding surface features on an outer surface of the temple 28. In some embodiments, particularly where the temple 28 of the eyewear device is too thin for one or more of the grips 78 to engage with the lower surface of the temple 28, one or more of surface features 80 may engage with the lower surface of the temple 28.

FIG. 6 illustrates a perspective view an example of the eyewear system including the ventilation apparatus 10 and the eyewear device 24. Frequently temples 28 are shaped with a curve to match the curve of a head of a user 38. Positioning and arrangement of the clip 30 may take this curvature into account to avoid misdirection of the eyewear tube 12. As illustrated in FIG. 6, the position of the inner prong 64 may cause the body 76 of the clip 30 to bend around the inner prong 64. This bending may create an arrangement wherein a back part of the body 76 between the inner prong 64 and the back end 86 of the clip 30 may be oriented toward the lens 40 of the front portion 26. Similarly, a front part of the body 76 between the front end 84 of the clip 30 and the inner prong 64 may be oriented away from the lens 40 of the front portion 26. In such an arrangement, the receptacles 60 for the eyewear tube 12 may be arranged on the back part of the body 76 to create the axis 82 along which the eyewear tube 12 is directed. This axis 82 may be offset from the orientation of the body 76 as a whole and the orientation of the temple 28 as a whole and may better direct fluid from eyewear tube 12 toward the front portion 26.

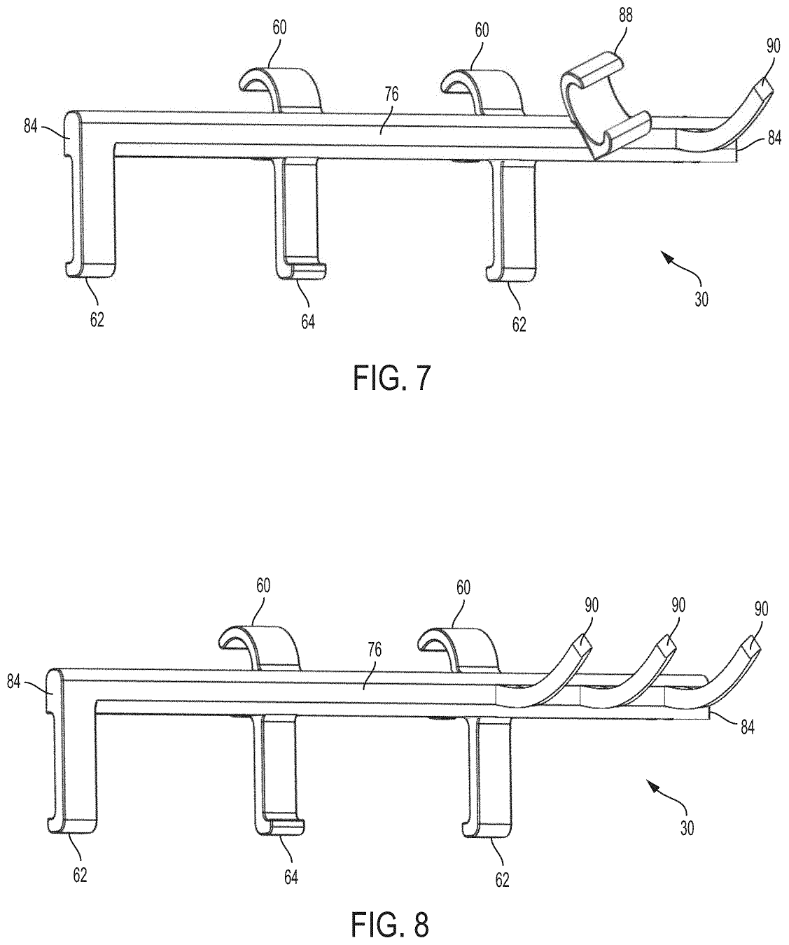

FIG. 7 illustrates a perspective view of an alternate example of the clip 30. In some embodiments, the clip 30 may include a mask receptacle 88 extending outwardly from the body 76 of the clip 30. The mask receptacle 88 may be any component of the clip 30 which is adapted to receive the mask tube 42. Examples of the mask receptacle 88 may include a partially circular crevice, a band encircling the mask tube 42, or a zip-tie encircling both the body 76 of the clip 30 and the mask tube 42. The mask tube 42 may be frictionally fit into the mask receptacle 88 or may be rigidly coupled within the mask receptacle 88. The mask receptacle 88 may extend outwardly from the outer side of the body 76 to avoid interference with the eyewear tube 12 or the ear of the user 38. The mask receptacle 88 may be oriented in a downward direction to facilitate the mask tube 42 bending over the ear of the user 38 and downward toward the mask 32.

The clip 30 may also include a mask hook 90 extending outwardly from the body 76 of the clip 30. The mask hook 90 may be any component of the clip which is adapted to receive the mask string 34. Examples of the mask hook 90 may include a curved projection, a ring, or a stud. The mask receptacle 88 may extend outwardly from the outer side of the body 76 to avoid interference with the eyewear tube 12 or the ear of the user 38. The mask string 34 of the mask 32 may be looped around the mask hook 90 to avoid interference with any other component of the ventilation apparatus 10 or the ear of the user 38.

FIG. 8 illustrates a perspective view of another example of the clip 30 including multiple mask hooks 90. In some embodiments, several mask hooks 90 may be arranged in sequence along the outer side of the body 76 of the clip 30. These mask hooks 90 may be used to customize the fit of the mask string 34 to the user's 38 comfort.

In some embodiments, the body 76 of the clip 30 may be secured to the temple 28 by a magnetic system instead of by prongs 62, 64. For example, the body 76 of the clip 30 may include a first magnet coupled to a side opposing the receptacle 60 and a second magnet may be coupled to temple 28. The first magnet and the second magnet may engage one another to secure the clip 30 to the temple 28. The first magnet may be embedded within the body 76 or may be coupled to the body 76 by an adhesive. Similarly, the second magnet may be embedded within the temple 28 or may be coupled to the temple 28 by an adhesive. In some embodiments, a large first magnet may be used to engage one or more smaller second magnets on the temple 28 to allow the position and orientation of the clip 30 to be adjustable.

FIG. 9 illustrates a side plan view of an example of the fan 14 and the fan housing 56. In some embodiments, the fan housing 56 may be divisible between a first portion 94 and a second portion 96. The first portion 94 and second portion 96 may be any components which, in combination, at least partially enclose the fan 14. The components of the first portion 94 and the second portion 96 may be interchangeable. For example, in some embodiments, the first portion 94 may be adapted to cover the inlet 112 of the fan 14. The first portion 94 may include a screen 98 which extends over the inlet 112 of the fan 14 and prevents large objects from entering the inlet 112 of the fan 14. Examples of the screen 98 may include a cage or a mesh. A filter 102 may be positioned between the screen 98 and the inlet 112 of the fan 14 to prevent particulate matter, as well as chemical and biological threats from entering the ventilation apparatus. The filter 102 may be any device capable of filter out particles, chemicals, and biologicals from the atmosphere and may be approved by the National Institute for Occupational Safety and Health of the Center for Disease Control. The first portion 94 of the fan housing 56 may be coupled to the fan 14 to secure the filter 102 between the first portion 94 and the fan 14. The first portion 94 may be removeable to replace the filter 102. In some embodiments, the screen 98 may be removeable to replace the filter 102 without removing the first portion of the fan housing 56. For example, the screen 98 may be twisted in some embodiments to remove the screen 98 from the first portion 94.

The second portion 96 of the fan housing 56 may include the manifold 16 and a wire channel 110. The manifold 16 may be arranged on the second portion 96 to position the manifold 16 over the outlet 92 of the fan 14 such that fluid from the outlet 92 of the fan 14 may pass through the manifold 16. As illustrated in FIG. 9, the manifold 16 may have female fittings 106 adapted to receive the tubes 12, 42. The inlets 114 of the tubes 12, 42 may be inserted into the manifold in a frictional seal, through a series of internal ribs and barbs, or through a flange-slot arrangement.

The wire channel 110 may be any component of the second portion 96 which is adapted to receive the wire 18 of the fan 14 and direct the wire 18 outward from the fan housing 56. Examples of the wire channel 110 may include a groove, a slot, or a divot. The wire channel 110 may form a seal with the wire 18 at an end of the second portion 96 to prevent infiltration of particulate matter or fluid into the fan housing 56.

The first portion 94 may include a first set of protrusions 100 adapted to secure the first portion 94 to the fan 14 or to the second portion 96. Similarly, the second portion 96 may include a second set of protrusions 104 adapted to secure the second portion 96 to the fan 14 or to the first portion 94. In some embodiments, screws may be inserted into the protrusions 100, 104 to secure the fan housing 56 to the fan 14. Alternatively, the first protrusions 100 may snap together to the second protrusions 104 to couple the fan housing 56 together and to secure the fan 14 between the first portion 94 and the second portion 96.

FIG. 10 illustrates a perspective view of another example of the fan housing 56. In some embodiments of the fan housing 56, the first portion 94 and the second portion 96 may include a number of pleat rods 116 extending across the inlet 112 of the fan 14. These pleat rods 116 may be arranged such that when a filter 102 is placed between the first portion 94 and the second portion 96, the filter 102 is pleated over the inlet 112 of the fan 14 allowing for better fluid intake and better filtration. As illustrated in FIG. 10, the first set of pleat rods 116 associated with the first portion 94 may extend deeper into inlet 112 than the second set of pleat rods 116 associated with the second portion 96. When in place, the filter 102 may be arranged under the first set of pleat rods 116 associated with the first portion 94 and over the second set of pleat rods 116 associated with the second portion 96, forming the pleated shape. This arrangement of the filter 102 with the pleat rods 116, may be accomplished through a set of sawtooth interfacing surfaces between the first portion 94 and the second portion 96, the first set of pleat rods 116 being placed at the trough of each sawtooth on the first portion 94 and the second set of pleat rods 116 being placed at the peak of each sawtooth on the second portion 96.

As illustrated in some embodiments, the manifold 16 may have male fittings 108 adapted to receive the tubes 12, 42. The inlets 114 of the tubes 12, 42 may be inserted over the male fittings 108 in a frictional seal, through a series of internal ribs and barbs, or through a flange-slot arrangement.

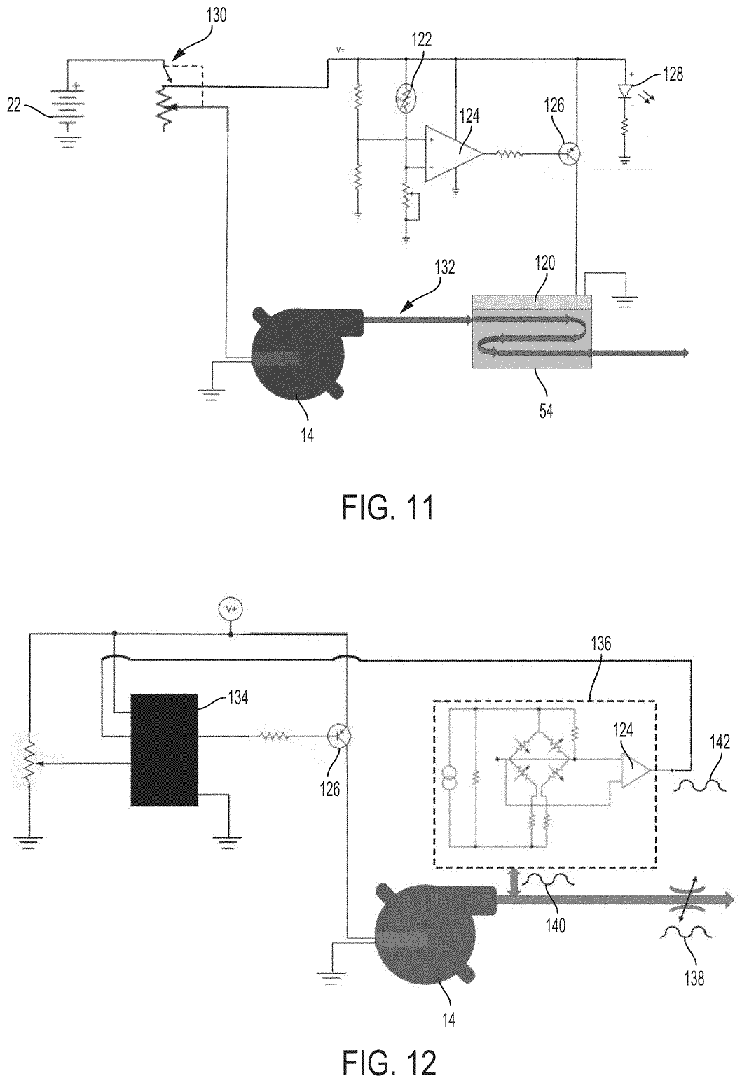

FIG. 11 illustrates an electrical diagram of an example of the ventilation apparatus 10. As shown, the ventilation apparatus 10 may also include a switch 130 configured to turn the fan 14 on and off. Alternatively, the switch 130 may be controllable to adjust the speed of the fan 14. Additionally, the ventilation apparatus 10 may include an On/Off Light-Emitting Diode (LED) 128 adapted to inform the user 38 when the ventilation apparatus 10 is operating. In some embodiments, the switch 130 may be located on the fan 14 or the fan housing 56. Alternatively, the switch 130 may be located on the wire 18 or closer to the electrical connector 20 to be within easy reach of the user 38 while wearing the ventilation apparatus 10.

In some embodiments, the heat exchanger 54 of the ventilation apparatus 10 may include a Peltier device 120. The Peltier device 120 may be any component which cools fluid passing through the heat exchanger 54 through an electrically generating thermal flux between two sides of the device. The Peltier device 120 may be positioned between the fan 14 and the outlet of the tubes 12, 42. When electricity is run through the Peltier device 120, a thermal flux may be created from a cooling side toward a heated side. The flow 132 of fluid through the heat exchanger 54 is directed to run alongside the cooling side of the Peltier device 120, cooling fluid passing through the heat exchanger 54. The Peltier device 120 may be electrically operated from the same electrical source 22 or from a separate source. In some embodiments, a thermistor 122 may be in contact with the heated side of the Peltier device 120. The thermistor 122, in connection with an amplifier 124 and a transistor 126, may be used to regulate the temperature of fluid passing through the heat exchanger 54. In some embodiments the heated side and cooling side of the Peltier device 120 may be reversed by reversing the flow of current through the Peltier device 120. In such embodiments, the heat exchanger 54 may be used to selectively condition fluid passing through the heat exchanger, configuring the Peltier device 120 to heat or cool the fluid as required.

FIG. 12 illustrates an electrical diagram of another example of the ventilation apparatus 10. In some embodiments, the ventilation apparatus 10 may include a pressure control system adapted to the volume of fluid flowing to the eyewear tubes 12 and the mask tube 42. The pressure control system may include a pressure sensor 136 in communication with the outlet 92 of the fan 14. The pressure 140 at the outlet 92 of the fan 14 may change as the user 38 wearing the mask 32 breathes in and out, alternatingly creating a positive and a negative pressure 138 within the mask tube 42. This changing pressure 138 within the mask tube 34 may also create a corresponding alternatingly positive and negative pressure 140 at the outlet 92 of the fan 14. Therefore, the pressure sensor 136 may be located at the outlet 92 of the fan 14, within mask tube 42, or at the mask nozzle 44.

The pressure sensor 136 may generate a changing electrical output 142 to a Peripheral Interface Controller (PIC) 134. The PIC 134 may compare the electrical output 142 to a set point and integrate the difference between these values to proportionally control the voltage delivered to the fan 14, adjusting the speed of the fan 14 to creating more or less fluid flow through the tube 12, 42. The set point may be set by a potentiometer or it may be preprogrammed into the PIC 134. This function may be especially useful in maintaining positive pressure within the interior region of the mask 32.

In some embodiments, the fan 14 may be powered by an analog controlled motor or an analog controlled motor with pulse-width modulation (PWM) feedback to control the speed of the fan 14 while minimizing power loss. A closed-loop PWM feedback embodiment may require the inclusion of additional input wires to the motor of the fan 14 to more precisely control the output of the motor. For example, an input to the controller 134 may provide the precise operating speed of the motor. As voltage from the electrical source 22 may vary over time, the controller may adjust the voltage to the motor to maintain constant operation speed of the fan 14.

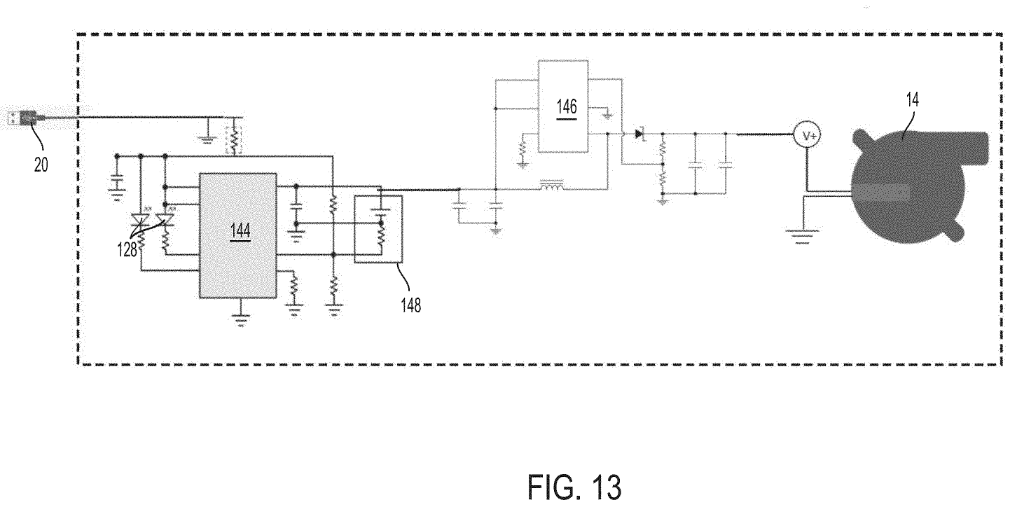

FIG. 13 illustrates an electrical diagram of yet another example of the ventilation apparatus 10. In some embodiments, the ventilation apparatus 10 may include an internal battery 148 to allow the ventilation apparatus 10 to continue operation temporarily when the fan 14 is not connected to the electrical source 22. The internal battery 148 may be connected to a charging system 144, which charges the internal battery while the fan 14 is connected to the electrical source 22. However, when the electrical source 22 is disconnected, for example, as when an external battery is changed out with another external battery, the internal battery 148 continues to provide electrical power to the fan 14 for a limited period of time. The ventilation apparatus 10 may also include one or more LEDs, for example, red and green LEDs, to indicate the charge status of the internal battery 148 or to indicate whether the fan 14 is being powered by the electrical source 22 or the internal battery 148.

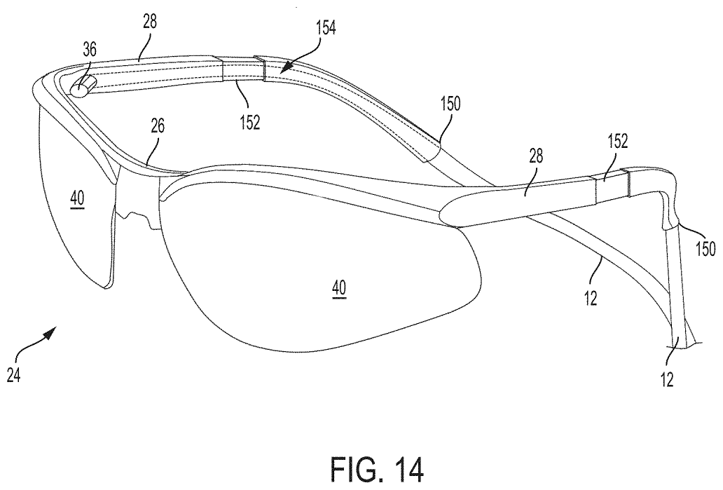

FIG. 14 illustrates a perspective view of another example of the eyewear system including the ventilation apparatus 10 and the eyewear device 24. In some embodiments, the eyewear tubes 12 may be directed to the front portion 26 of the eyewear device 24 internally through the temples 28 of the eyewear device 24. The eyewear tubes 12 may enter the interior of the temples 28 at a temple tip 150 or at some other area of the temple 28. Alternatively, the eyewear tubes 12 may enter the interior of the temples 28 at some other point along the length of the temple 28 between the hinge at the front portion 26 and the temple tip 150. The eyewear nozzle 36 may extend outward from the temple 28 proximate to the front portion 26 of the eyewear device 24 and may direct fluid passing through the temple 28 toward the lens 40 of the eyewear device 24. The eyewear tube 12 may extend through the interior of the temple 28, or fluid passing through the temple 28 may pass through an interior temple channel 154. In some embodiments, the eyewear tube 12 may extend through the temple 28 and through the hinge between the temple 28 and the front portion 26 of the eyewear device 26. Such an embodiment may minimize contact between the user 38 and the eyewear tube 12 and allow the eyewear nozzle 36 to deliver fluid directly across or at the lens 40 of the front portion 26.

In some embodiments, the temples 28 of the eyewear device 24 may include an expandable portion 152 which allows the length of the temple 28 to be adjusted. Examples of the expandable portion 152 may include a telescoping section, as illustrated in FIG. 14. An adjustable length temple 28 may be desirable to ensure that the temple tips 150 are positioned close to the ears of the user 38, preventing the eyewear tubes 12 from exerting a lever force and tipping the front portion 26 away from the eyes of the user 38.

Furthermore, although specific components are described above, methods, systems, and articles of manufacture described herein may include additional, fewer, or different components. For example, the clip 30 may contain additional prongs 72, 74 or fewer prongs 72, 74.

In addition to the advantages that have been described, it is possible that there are other advantages that are not currently recognized. However, these advantages which may become apparent at a later time. While various embodiments have been described, it will be apparent to those of ordinary skill in the art that many more embodiments and implementations are possible. Accordingly, the embodiments described herein are examples, not the only possible embodiments and implementations.

What is claimed is:

I claim,:

1. An eyewear ventilation apparatus, comprising:
a fan comprising an inlet and an outlet;
a manifold in fluid communication with the outlet of the fan;
a plurality of tubes, each of the plurality of tubes comprising an inlet in fluid communication with the manifold, and an outlet; and
a directional device configured to secure at least one of the plurality of tubes to a temple of an eyewear device and configured to direct fluid from the outlet of the at least of the plurality of tubes onto a region.

2. The eyewear ventilation apparatus of claim 1, wherein at least one of the plurality of tubes comprises a nozzle situated on the outlet, wherein the nozzle comprises a preformed curve configured to direct fluid flow passing through the nozzle.

3. The eyewear ventilation apparatus of claim 1, wherein the plurality of tubes comprises a first tube coupled to the directional device and configured to direct fluid from the outlet of the first tube onto a portion of an eyewear device, and a second tube configured to direct fluid from the outlet of the second tube into an interior region of a mask.

4. The eyewear ventilation apparatus of claim 3, wherein the plurality of tubes comprises a third tube coupled to a second directional device, wherein the second directional device is configured to secure the third tube to a second temple of the eyewear device opposing the temple associated with the directional device of the first tube, and wherein the second directional device is configured to direct fluid from the outlet of the third tube onto a second portion of the eyewear device.

5. The eyewear ventilation apparatus of claim 3, wherein the inlet of the second tube is coupled to the outlet of the manifold.

6. The eyewear ventilation apparatus of claim 3, wherein the inlet of the second tube is coupled to and in fluid communication with an opening within the first tube, wherein the opening is arranged between the inlet and the outlet of the first tube.

7. The eyewear ventilation apparatus of claim 6, wherein the second tube comprises a flattened nozzle situated on the outlet, wherein the flattened nozzle is configured to fit underneath a mask.

8. The eyewear ventilation apparatus of claim 6, further comprising a temperature control system configured to condition fluid passing through the manifold and the plurality of tubes to adjust a temperature of fluid passing through the outlet of the plurality of tubes.

9. The eyewear ventilation apparatus of claim 8, wherein the temperature control system comprises a Peltier device positioned between the fan and the plurality of tubes.

10. The eyewear ventilation apparatus of claim 1, further comprising an internal battery to power the fan.

11. The eyewear ventilation apparatus of claim 1, further comprising a housing positioned over the inlet of the fan, and a filter positioned between the inlet of the fan and the housing.

12. An eyewear system, comprising:
an eyewear device comprising, a front portion extending between a first end and a second end, a first temple coupled to the first end of the front portion, and a second temple coupled to the second end of the front portion; and
a ventilation apparatus comprising:
a fan having an inlet and an outlet;
a manifold in fluid communication with the outlet of the fan;
a first tube comprising a first inlet in fluid communication with manifold, and a first outlet;
a second tube comprising a second inlet in fluid communication with the manifold, and a second outlet; and
a directional device coupled to the first tube and to the first temple, wherein the directional device is configured to secure the first tube to the first temple of the eyewear device and to direct fluid from the first outlet of the first tube onto the front portion of the eyewear device.

13. The eyewear system of claim 12, wherein the directional device is the first temple of the eyewear device, and wherein the first tube extends through an interior of the first temple.

14. The eyewear system of claim 12, further comprising a mask, wherein the second tube is configured to extend into an interior region of the mask.

15. The eyewear system of claim 14, further comprising a pressure sensor adjacent to the outlet of the second tube, and a pressure control system configured to adjust a rotational speed of the fan to control the pressure within the interior region of the mask.

16. The eyewear system of claim 14, further comprising a mask fastener coupled to the second tube, wherein the mask fastener is configured to secure the second tube to the mask.

17. A clip configured to couple a tube to a temple of an eyewear device, the clip comprising:
a body comprising a first side, a second side, wherein the body extends from a first end to a second end;
a first prong extending downward from the body on the first side;
a second prong extending downward from the body on the second side;
a third prong extending downward from the body on one of the first side or the second side, wherein the first prong, the second prong, and the third prong are each configured to engage the temple of the eyewear device; and
a receptacle extending outward from the body, wherein the receptacle is configured to receive the tube.

18. The clip of claim 17, wherein the receptacle comprises a first receptacle and a second receptacle, each of the first receptacle and the second receptacle configured to receive a portion of a tube, and wherein the first receptacle and the second receptacle are aligned along an axis to direct a flow of fluid through the tube.

19. The clip of claim 17, wherein the receptacle comprises a first receptacle extending outwardly from the first side of the body, and a second receptacle extending outwardly from the second side of the body.

20. The clip of claim 19, further comprising a mask hook extending outwardly from the second side of the body, wherein the mask hook is configured to receive a cord of a mask.
